(19) United States
(12) Patent Application Publication
(10) Pub. No.: US 2010/0235079 A1
(43) Pub. Date: Sep. 16, 2010

(54) Navigation apparatus

(75) Inventor: Kenji Takashima, Obu-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/656,573

(22) Filed: Feb. 4, 2010

(30) Foreign Application Priority Data
Mar. 13, 2009 (JP) 2009-61104

(51) Int. Cl. G01C 21/36

(52) U.S. Cl. 701/200

(57) ABSTRACT

A navigation apparatus for a vehicle is disclosed. The navigation apparatus includes a map data storage section storing therein road map data; a guidance route retrieval section configured to retrieve a guidance route between a departure point and a destination point based on the road map data; and a navigation route setting section configured to set a navigation route for use in route guidance based on the retrieved guidance route. When the destination point is set to a facility having multiple places for arrival, the guidance route retrieval section retrieves multiple guidance routes from the departure point to the multiple places for arrival. When the multiple guidance routes include one guidance route that does not require the vehicle to make a U-turn on a road around the facility, the navigation route is set to the one guidance route.

### CROSS REFERENCE TO RELATED APPLICATION

The present application is based on Japanese Patent Application No. 2009-61104 filed on Mar. 13, 2009, disclosure of which is incorporated herein by reference.

### BACKGROUND OF THE INVENTION

1. Field of the Invention

The present invention relates to a navigation apparatus that retrieves a route between a departure point and a destination point based on road map data.

2. Description of Related Art

Various techniques for a navigation apparatus have been proposed to provide a route reflecting user preferences. For example, JP-2000-337909A discloses a technique of retrieving multiple routes based on multiple different, retrieval conditions and displaying the retrieved routes and names of the retrieval conditions so that a relationship between the retrieved routes and the names of the retrieval conditions is visually perceivable. JP-2003-083757A discloses a technique of accepting entry of via-points from a user and retrieving a route that leads to a destination point through all of the via-points in the most efficient order.

The inventor of the present application has found that a conventional technique involves the following difficulties. A typical navigation apparatus performs route retrieval based on a representative location of a destination facility. The facilities settable as a destination point for route retrieval include a large facility such as an airport and a railway station. Such a large facility may have multiple places for arrival (e.g., parking lots, unloading zones) that can be a vehicle arrival location. When a conventional navigation apparatus retrieves a route to such a large facility, if a representative location of the large facility does match a parking lot or an unloading zone, the conventional navigation apparatus may not guide a vehicle to a place at which the vehicle is allowed to park or stop. In some cases, a representative location of a facility is set to, for example, a center of the facility without taking into consideration a road condition and the like around the facility. Thus, when a navigation apparatus guides a vehicle to a representative point and when the vehicle follows the route guidance, the route guidance may end on an opposite side of a central median of a road from the destination facility, or the vehicle may be required to make a U-turn on a road around the destination point.

The inventor has considered the following technique. When a destination point for use in route retrieval is set to a facility having multiple parking lots or the like, a list of the multiple parking lots is displayed so that a user can select one parking lot as a destination point from the multiple parking lots. However, since many parking lots can be displayed on a screen, a user unfamiliar with the facility may have a difficulty in determining which parking lot should be selected to easily reach the facility. Depending on the selected parking lot, a navigation apparatus may set such an inconvenient route that requires a vehicle to make a U-turn on a road around a destination facility.

### SUMMARY OF THE INVENTION

In view of the above and other difficulties, it is an objective of the present invention to provide a navigation apparatus that is capable of providing an appropriate navigation route leading to a destination point even when the destination point is set to a facility having multiple places for arrival.

According to an aspect of the present invention, a navigation apparatus for a vehicle is provided. The navigation apparatus includes: a map data storage section storing therein road map data; a departure point setting section configured to set a departure point; a destination point setting section configured to set a destination point; a guidance route retrieval section configured to retrieve a guidance route between the departure point and the destination point based on the road map data; and a navigation route setting section configured to set a navigation route for use in route guidance based on the retrieved guidance route. When the destination point setting section sets the destination point to a facility having a plurality of places for arrival, the guidance route retrieval section retrieves a, plurality of guidance routes that respectively leads from the departure point to the plurality of places for arrival. When the plurality of guidance routes includes one guidance route that does not require the vehicle to make a U-turn on a road around the facility, the navigation route setting section sets the navigation route to the one guidance route.

According to the above navigation apparatus, it is possible to provide an appropriate navigation route leading to a destination point even when the destination point is set to a facility having a plurality of places for arrival. The navigation apparatus is capable of providing a navigation route that enables a user to easily reach a destination facility.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram illustrating a navigation apparatus according to one embodiment;

FIG. 2 is a functional block diagram of a controller according to one embodiment;

FIG. 3 is a flowchart illustrating a navigation procedure according to one embodiment;

FIG. 4 is a flowchart illustrating a navigation route setting process according to one embodiment;

FIG. 5 is a diagram illustrating routes to a facility having multiple places for arrival according to one embodiment;

FIG. 6 is a diagram illustrating routes to a facility having multiple places for arrival according to a comparison example; and

FIG. 7 is a diagram illustrating routes from different departure point according to one embodiment.

### DETAILED DESCRIPTION OF THE EXEMPLARY EMBODIMENTS

The exemplary embodiments will be described below with reference to the accompanying drawings.

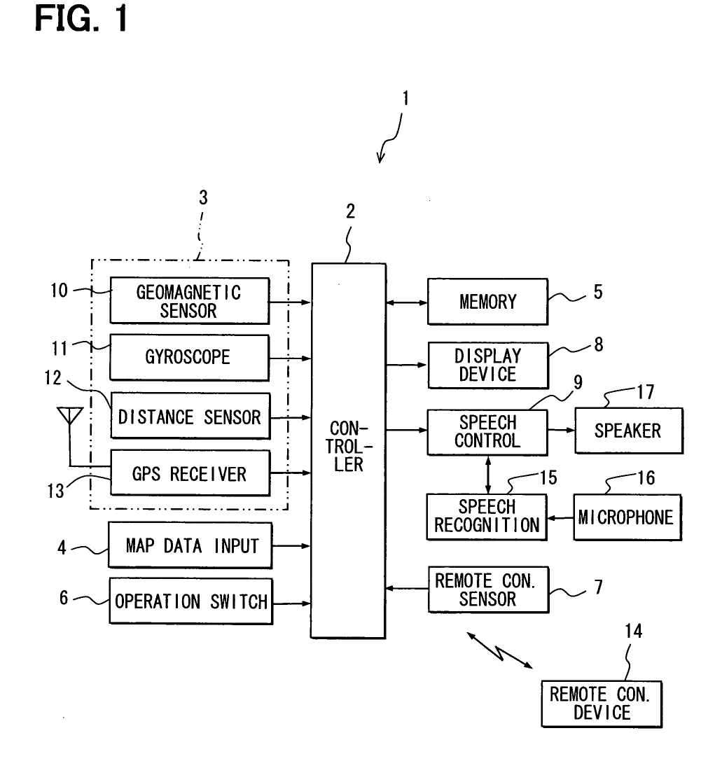

FIG. 1 is a functional block diagram illustrating a navigation apparatus 1 mounted to a vehicle. The navigation apparatus 1 includes a position detector 3, a map data input device 4, a memory 5, a group of operation switches 6, a remote control sensor 7, a display device 8, and a speech control device 9 and a controller 2 connecting and controlling the foregoing components. The memory 5 may be external with respect to the controller 2.

The controller 2 includes a microcomputer as a main component. The microcomputer includes a CPU, a ROM, a RAM and the like. The ROM stores therein a program for a navigation function and the like. The RAM temporarily stores processing data in execution of a program, road map data acquired via the map data input device 4, or the like.

The position detector 3 may include a geomagnetic sensor 10 for detecting absolute orientation of the vehicle, a gyroscope 11 for detecting relative orientation of the vehicle, a distance sensor 12 for detecting travel distance of the vehicle, and a GPS (Global Positioning System) receiver 13 for receiving a signal from a GPS satellite. The position detector 3 detects position of the vehicle with high accuracy in such way that detection signals of the above components of the position detector 3 compensate each other. Depending on required detection accuracy, the position detector 3 may, for example, include only some of the above sensors, or may further include an acceleration sensor for detecting acceleration of the vehicle.

The map data input device 4 inputs various data by utilizing a mass-storage medium such as a CD-ROM, a DVD-ROM, a hard disk drive, a non-volatile semiconductor memory and the like. The various data includes road map data, mark data, data for map matching, facility data and the like. The map data input device 4 can act as a map data storage section or means.

The road map data includes data for road shape, road width, road type (e.g., open road, prefectural road, national road, freeway, tollway), traffic light, railway crossing and the like. The road map data further includes data for displaying a road map on a screen of the display device 8. The road map data further includes information on traffic regulations. For example, the road map data indicates whether a road is for one-way traffic, whether a vehicle is not allowed to enter a road, and the like.

The facility data includes information on facilities that are settable as a destination point for route guidance. More specifically, the facility data includes information on: transport facilities such as airport and railway station; facilities such as leisure facility, accommodation facility and public facility; various stores such as retail store, department store and restaurant; houses; apartment buildings; names of places; and the like. The facility data further includes telephone numbers and addresses of facilities, and location information (e.g., latitude and longitude) of representative locations of facilities. A representative point of a facility may be a center of the facility. The facility data further includes data for displaying a landmark representative of a facility on a road map on the screen of the display device 8.

Out of the above facilities, some facilities have a place for arrival, at which a vehicle may be allowed to park or stop. A large facility such as an airport and a railway station typically has multiple places for arrival, e.g., parking lot, unloading zone. The facility data according to the present embodiment includes location information on a place for arrival associated with a facility, such that the facility and the location information on the place for arrival are related to each other.

The memory 5 may be, for example, a hard disk drive or a rewritable nonvolatile memory such as a flash memory or the like. The memory 5 is provided to store and output predetermined data such as point registration data, music data, image data and the like.

The group of operation switches 6 includes a mechanical switch arranged close to the screen of the display device 8 and a touch panel arranged on the screen of the display device 8. The group of operation switches 6 can be used to input a variety of information to the controller 2. The variety of information includes a destination point, a destination point retrieval condition (which is used in destination point retrieval), a via-point, and the like. The variety of information further includes a command to change display of the screen of the display device 8, a command to change map scale, a command to display a menu window, a command to start performing route guidance, a command to correct the present position, a command to adjust sound volume, and the like.

The remote control device 14 has multiple switches (not shown). In response to manipulation of the switch, the remote control device 14 can output a variety of instruction signals (i.e., command) to the controller 2 via the remote control sensor 7. The same command can be issued to the controller 2 regardless of which one of the remote control device 14 and the group of operation switches 6 is manipulated.

The display device 8 displays a map and a character (letter), and is arranged close to a driver seat of the vehicle. The display device 8 may be a color liquid crystal display device. A map can be displayed on the screen of the display device 8 with various scales. A vehicle position mark indicative of the present location and the heading direction of the vehicle can be superimposed on the map. During route guidance for guiding the vehicle to a destination point, the display device 8 displays a window for route guidance, a variety of messages, a window for input, and the like. The window for input enables a user to input information required for destination point retrieval, start retrieving a destination point, and make a destination point setting.

The speech recognition device 15 stores therein dictionary data for speech recognition, and matches the dictionary data to the speech inputted via the microphone 16 to recognize the inputted speech. The speech control device 9 controls the speech recognition device 15, outputs a result of the speech recognition to the controller 2, and causes the speaker 17 to talk back the recognized speech. The speech control device 9 outputs a speech output signal to the speaker 17 based on a speech output command from the controller 2. The speech outputted from the speaker 17 includes a speech associated with route guidance; a speech associated with explanation on operation, and the talked back speech associated with a result of speech recognition.

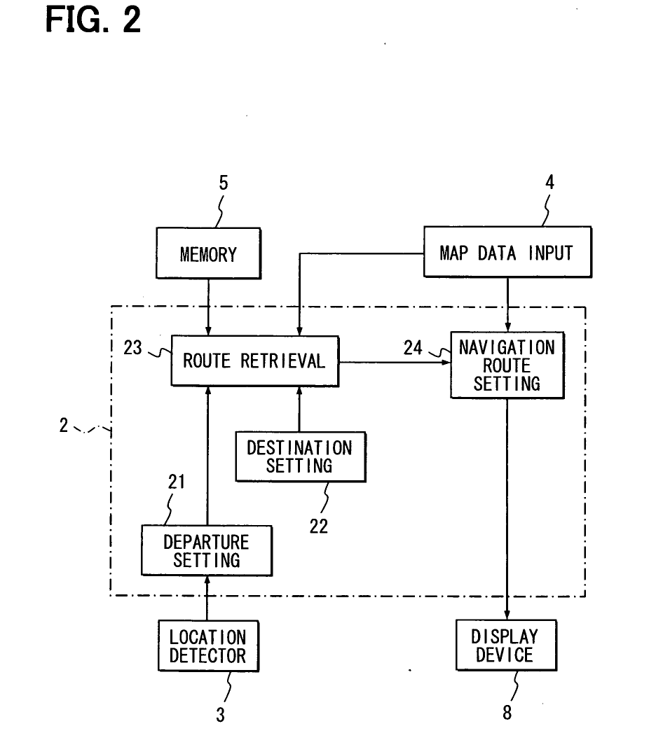

FIG. 2 is a functional block diagram of the controller 2. As shown in FIG. 2, the controller 2 includes or can act as a departure point setting section or means 21, a destination point setting section or means 22, a guidance route retrieval section or means 23, and a navigation route setting section or means 24. When a user selects or sets a certain point as a departure point through manipulating the group of operation switches 6 or the remote control device 14, the departure point setting section 21 sets a departure point to the certain point. When the certain point is not selected or set, the departure point setting section 21 sets the departure point to the present location of the vehicle detected by the position detector 3.

The destination point setting section 22 causes the display device 8 to display a destination-setting-window or causes the speaker 17 to output the sound that encourages to set a destination point. The destination point setting section 22 sets a destination point to a certain point, which a user may select or set through manipulating the group of operation switches 6 or the remote control device 14.

The route retrieval section 23 calculates and retrieves an optimum guidance route between the departure point and the destination point. Dijkstra's method may be employed as a guidance route retrieval method. When the destination point is set to a facility having multiple places for arrival (e.g., parking lots, unloading zones), the route retrieval section 23 retrieves multiple guidance routes that respectively lead from the departure point to the multiple places for arrival.

The navigation route setting section 24 sets a navigation route based on the guidance route retrieved by the guidance route retrieval section 23. When the guidance route retrieval section 23 retrieves multiple guidance routes, the navigation route setting section 24 selects a guidance route satisfying a predetermined selection condition for being a navigation route, and sets a navigation route to the selected guidance route. When only one guidance route is retrieved, the navigation route is set to the guidance route. The predetermined selection condition includes a first condition and a second condition. The first condition is that a guidance route does not require a vehicle to make a U-turn on a road around a destination facility. The second condition is that a guidance route is shortest.

The navigation route setting section 24 makes route guidance data based on the navigation route and the various information (road shape information, intersection information, railway crossing information) in the road map data. The route guidance data is used in a route guidance operation, in which the display device 8 and/or the speaker 17 provide information indicating that, for example, “turn right or left at an intersection ahead”, or, “take care of a railway crossing ahead”.

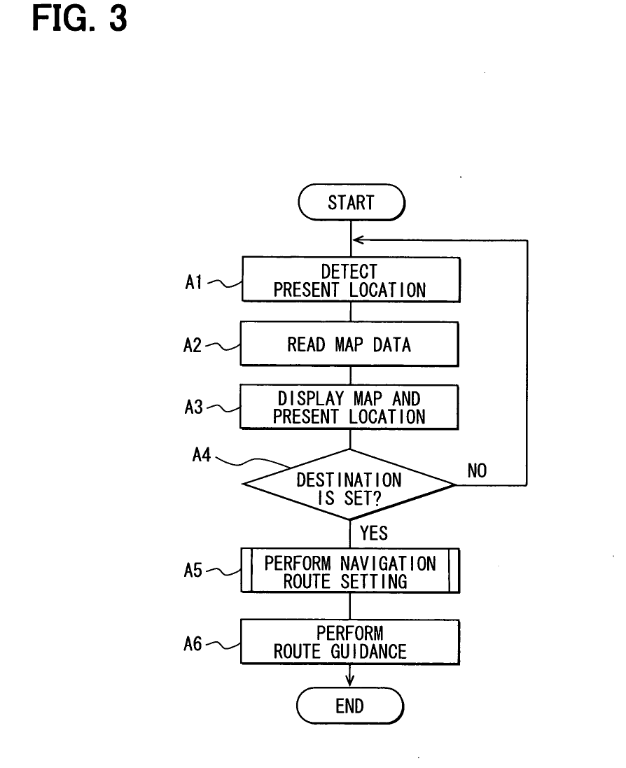

Operation of the navigation apparatus 1 is described below with reference to FIGS. 3 to 7. FIG. 3 is a flowchart illustrating a navigation procedure, which is driven by the controller 2. At A1, the controller 2 acquires the present position of the vehicle via the position detector 3. At S2, the controller 2 acquires road map data showing a road map around the present position of the vehicle via the map data input device 4. At A3, the controller 2 causes the display device 8 to display the road map around the present position of the vehicle on the screen of the display device 8, and superimposes the present position mark to indicate the present location and the heading direction of the vehicle on the road map.

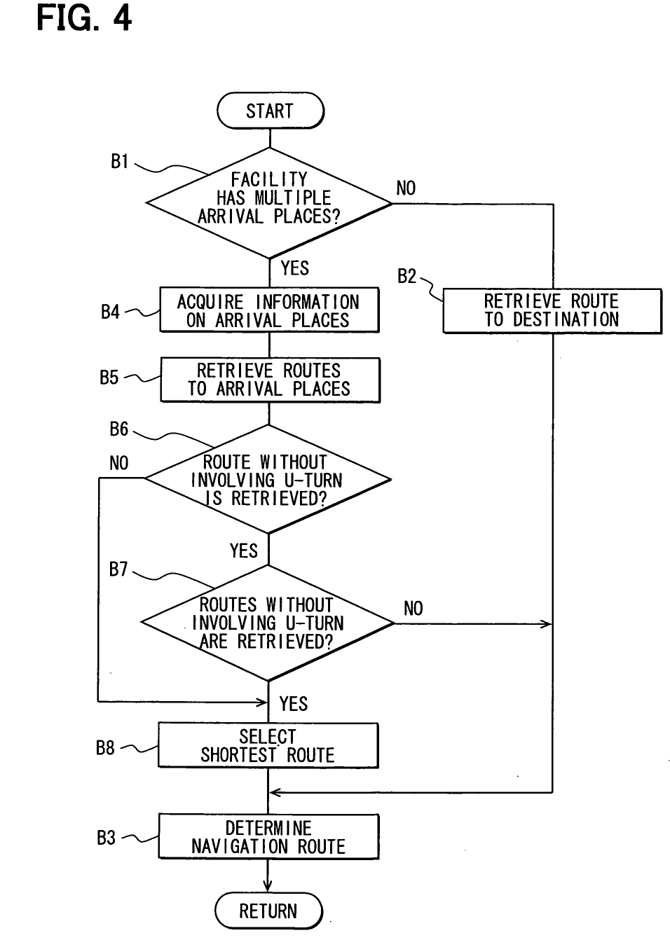

At A4, the controller 2 determines whether a destination point is set. When a destination point is set by a user, corresponding to “YES” at A4, and the procedure proceeds to A5 where a navigation route setting process is performed. Details of the navigation route setting process will be later described with reference to FIG. 4. When it is determined that a destination point is not set, corresponding to “NO” at A4, the procedure returns to A1 so that the processes A1 to A3 are preformed again. Through cyclically performing A1 to A3, the present position mark is moved on the road map in synchronization with movement of the vehicle, and the road map is scrolled in accordance with a change in the present position of the vehicle. During this operation, the map matching is performed to match the present location of the vehicle with location of a road.

At A5, a navigation route is set. At A6, a route guidance operation is performed for guiding the vehicle along the navigation route. In the route guidance operation at A6, the processes similar to A1 to A3 are performed to display the road map around the present position of the vehicle and the present position mark. At A6, a road corresponding to the navigation route is highlighted in different color on the road map. Further, when the vehicle approaches an intersection or a crossroad, a guidance operation is performed as needed. When the vehicle arrives at the destination point, or when an instruction to end the navigation procedure is inputted, the route guidance operation is ended and the navigation procedure is ended.

FIG. 4 is a flowchart illustrating a navigation route setting process. Explanation of the navigation route setting process is first given on a case where the destination point set at A4 (see FIG. 3) is a facility (e.g. a house) having no place for arrival (e.g., a parking lot). In this case, the navigation route setting process to be performed may be substantially identical to a conventional navigation route setting process. More specifically, because there is no place for arrival in the destination facility, the determination “NO” is made at B1, and the process proceeds to B2. At B2, the controller 2 retrieves a guidance route from the departure point to a representative location of the facility. Then, at B3, the controller 2 sets the navigation route to the retrieved guidance route.

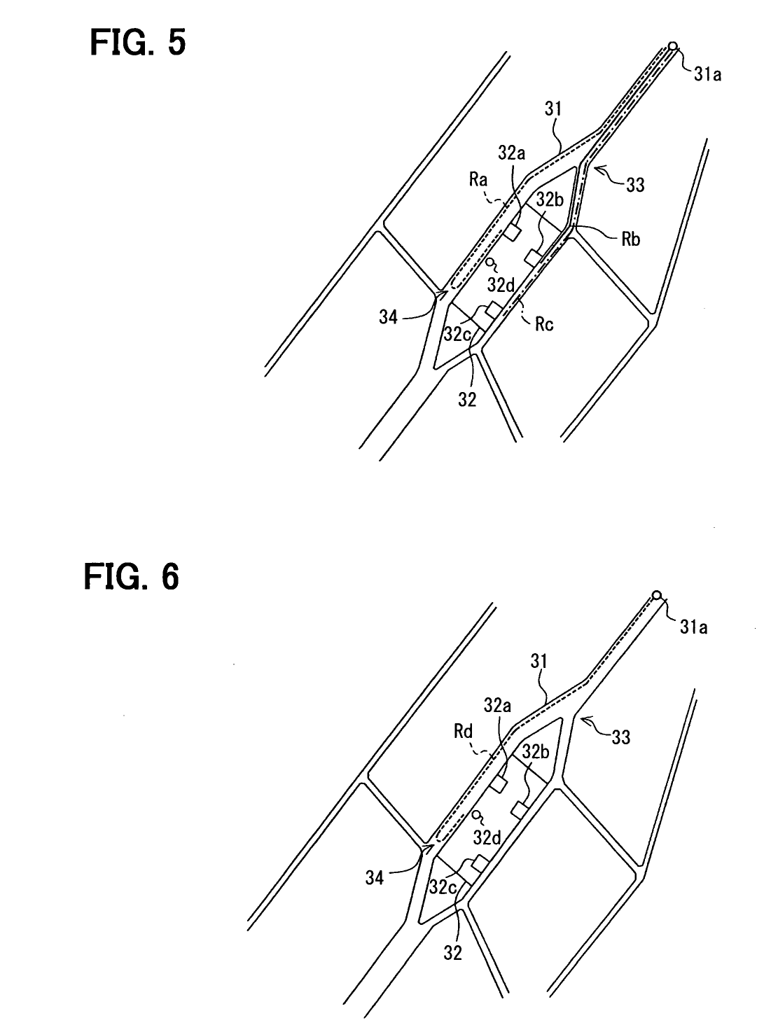

Explanation of the navigation route setting process is given on a case where the destination point set at A4 (see FIG. 3) is a facility (e.g. a railway station) having multiple places for arrival. FIG. 5 is a diagram illustrating a road map around a railway station having multiple parking lots as multiple places for arrival. Regarding the road map of FIG. 5, the following situation is assumed. The destination point is set to the railway station 32. A railway station 32 has three parking lots 32a to 32c. A representative location of the railway station 32 is a location 32d. There is a traffic regulation “drive on the right”. A road 31 is a divided road, in which the two directions of traffic are separated by a central median. The vehicle is at a location 31a on a road 31 and the departure point is set to the location 31a.

In the case of FIG. 5, since the railway station 32, which is set as the destination point, has three parking lots 32a to 32c, the determination “YES” is made at B1 and the process proceeds to B4. At B4, location information (e.g., latitude and longitude) of the parking lots 32a to 32c is acquired. At B5, the guidance routes Ra to Rc from the location 31a to the parking lots 32a to 32c are retrieved.

The guidance route Ra, which leads from the location 31a to the parking lot 32a, can be described as follows. The guidance route Ra extends from the location 31a, turns right at an intersection 33, extends to an intersection 34 while passing through the parking lot 32a, makes a U-turn at the intersection 34, and reaches the parking lot 32a. A reason why the guidance route Ra passes through the parking lot 32a on the way to the parking lot 32a is that the road 31 is a divided route, and the parking lot 32a and the vehicle are located on opposite sides of the central median of the road 31.

The guidance route Rb from the location 31a to the parking lot 32b can be described as follows. The guidance route Rb extends from the location 31a, turns left at the intersection 33, and extends straightly to parking lot 32b. The guidance route Rc from the location 31a to the parking lot 32c can be described as similarly as the guidance route Rb. It should be noted that an end part of the guidance route Rc has a longer straight distance than that of the guidance route Rb.

At subsequent steps B6 to B8, one guidance route is selected from the retrieved guidance routes Ra to Rc based on the predetermined selection condition. More specifically, when the guidance routes Ra to Rc include a guidance route satisfying the first condition (a guidance route does not require the vehicle to make a U-turn on a road around the railway station 32), the guidance route satisfying the first condition is selected. When the guidance routes Ra to Rc include two or more guidance routes satisfying the first condition, one guidance route satisfying the second condition (a guidance route is shortest) is selected from the two or more guidance routes. When each of the guidance routes Ra to Rc does not satisfy the first condition, one guidance route satisfying the second condition (a guidance route is shortest) is selected from the guidance routes Ra to Rc.

In the case of FIG. 5, the guidance route Ra requires a vehicle to make a U-turn, whereas the guidance routes Rb and Rc do not require a vehicle to make a U-turn. Hence, out of the guidance routes Ra to Rc, the two guidance routes Rb and Rb do not require a U-turn, corresponding to “YES” at both of B6 and B7. Comparison in distance between the guidance routes Rb and Rc shows that the guidance route RB is shorter than the guidance route Rc. Thus, the guidance route Rb is selected at B8, and set as the navigation route at B3.

As a comparison example, explanation is given on a case where a destination point is set to the representative location 32d of the railway station 32 and a guidance route from the location 31a to the railway station 32 is retrieved by a conventional navigation apparatus. FIG. 6 is a diagram illustrating a guidance route retrieved by a convention navigation apparatus. It should be noted that the road map illustrated in FIG. 6 is the same as that illustrated in FIG. 5.

The representative location 32d of the railway station 32 and the parking lot 32a are on the same side of the road. A guidance route Rd retrieved by the conventional navigation apparatus is substantially identical to the guidance route Ra. Thus, the guidance route Rd requires a vehicle to make a U-turn on a road around the railway station 32. A route guidance of the conventional navigation apparatus complicates the driving around the railway station 32.

It is further assumed that a road sign is provided at the intersection 33, for a vehicle traveling from the location 31a toward the railway station 32. In general, such a local road sign guides a vehicle to a certain place while not require a vehicle to make a U-turn. Thus, it is natural that the road sign guides a vehicle to the parking lot 32b by instructing a vehicle to turn left at the intersection 33. In this case, when a vehicle follows the route guidance of the conventional navigation apparatus, a vehicle should turn left at the intersection 33 by not following the instruction provided by the road sign. A user may have a feeling of strangeness accordingly.

According to the navigation apparatus 1 of the present embodiment, the navigation route is set to the guidance route Rb leading from the location 31a to the parking lot 32b of the railway station 32, and thus does not require a vehicle to make a U-turn on a road around the railway station 32, and guides a vehicle to the destination point by the shortest way. The navigation apparatus 1 does not complicate the driving around the railway station 32. Further, since the vehicle can turn left at the intersection 33 by following the route guidance of the navigation apparatus 1 in agreement with the instruction provided by the road sign, a user can smoothly reach the railway station without having a feeling of strangeness.

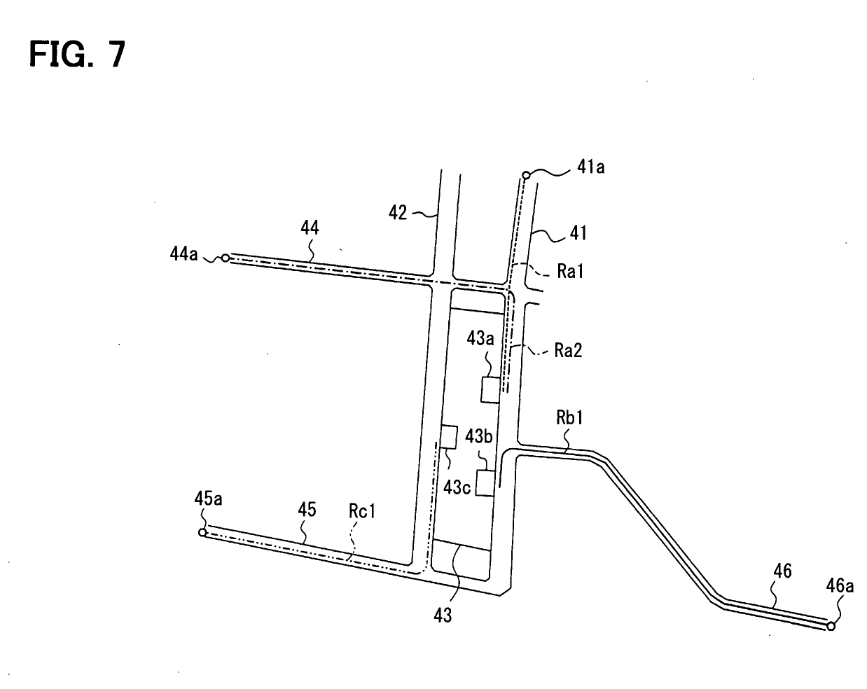

As seen from the above exemplary cases, the navigation route setting process can set an appropriate navigation route from the location 31a to the railway station 32. When the departure point is different from the location 31a, an appropriate navigation route can be different. With reference to FIG. 7, explanation is given below on another case where a navigation route is set to one of multiple guidance routes from different departure points to a facility (that act as a destination point) having multiple places for arrival. FIG. 7 is a diagram illustrating multiple routes from different locations to a railway station having multiple parking lots. As is the cases for FIGS. 5 and 6, it is assumed in FIG. 7 that there is a traffic regulation “Keep on the right” and each of roads 41, 42 is a divided road.

As shown in FIG. 7, the railway station 43, which is set as a destination point, has three parking lots 43a to 43c. First, suppose that a vehicle is at a location 41a on a road 41, and the departure point is set to the location 41a. In this case, each of three guidance routes for guiding a vehicle to the parking lots 43a to 43c does not require U-turn, corresponding to “NO” at B6. The shortest guidance route is selected from the three guidance routes at B8. Since the guidance route Ra1 for guiding a vehicle to the parking lot 43a is shortest, the navigation route is set to the guidance route Ra1 at B3.

Suppose that the departure point is a location 44a on a road 44. In this case, each of two guidance routes for guiding a vehicle to the parking lots 43a and 43b does not require a U-turn, corresponding to “YES” at B6 and B7. The shorter guidance route is selected from the two guidance routes at B8. Since the guidance route Ra2 for guiding a vehicle to the parking lot 43a is shortest, the navigation route is set to the guidance route Ra2 at B3. Suppose that the departure point is a location 45a on a road 45. In this case, only a guidance route for guiding a vehicle to the parking lot 43c does not require a U-turn, corresponding to “YES” at B6 and “NO” at B7. The navigation route is set to the guidance route Rc at B3.

Suppose that the departure point is a location 46a on a road 46. In this case, each of two guidance routes for guiding a vehicle to the parking lots 43b and 43c does not require a U-turn, corresponding to “YES” at B6 and B7. Since the guidance route Rb1 for guiding a vehicle to the parking lot 43b is shortest, the navigation route is set to the guidance route Rb1 at B3. As seen above, even when guidance routes leading from different locations to the railway station 43 are retrieved, it is possible to set a navigation route to an optimum guidance route.

The above embodiment can be modified in various ways, examples of which will be described.

At B2 or B4 in FIG. 4, the controller 2 may retrieve a guidance route from the present position of the vehicle to a destination (e.g., facility or place for arrival) in accordance with a specified condition such as a recommendation priority, a tollway priority, a freeway priority, distance priority and the like. In this configuration, information on retrieved guidance routes may be provided to a user through a screen of the display device 8, so that a user can select a desired guidance route from the retrieved guidance routes.

The destination point setting section 22 may be configured such that each place for arrival of a facility is settable as a destination point. In this configuration, the controller 2 may further perform, prior to B1 in FIG. 4 for instance, a process of determining whether a place for arrival of a facility is set as the destination point. When a place for arrival of a facility is set as a destination point, a guidance route from the departure point to the place for arrival may be retrieved, and the navigation route may be set to the retrieved guidance route at B3. According to the above manner, the navigation route can be set to a guidance route that leads to a place meeting user preference, such as a user-desiring parking lot and the like.

A place for arrival may not be limited to a place where a vehicle is allowed to park or stop. For example, a place for arrival may include a place that is settable as a destination point according to the navigation function, and may include an entrance of a facility for instance. Further, a place for arrival may not be limited to a place in a facility. For example, when a facility is a railway station, a place for arrival of the railway station may not be limited to a parking lot that is located on a premise of and dedicated to the railway station. A place for arrival of the railway station may include a pay-or-free parking lot that is located around the railway station. In this configuration, the facility data may include data for a relationship between such a railway station and a pay-or-free parking lot around the railway station.

The facility data may include vehicle guide information for use in guiding a vehicle located around a predetermined facility toward the predetermined facility having multiple places for arrival. In this configuration, when the destination point is set to a predetermined facility whose information is contained in the vehicle guide information, the route retrieval section 23 may retrieve a guidance route based on the vehicle guide information.

When guidance routes are not narrowed down to one guidance route at B3 in FIG. 4, in other words, when there are multiple guidance routes each satisfying both of the first condition (i.e., no U-turn is required) and the second condition (i.e., shortest route), a route selection process is added after B3, so that a user can select one guidance route from the multiple guidance routes. According to the above manner, when each of multiple guidance routes can be an appropriate navigation route, the navigation apparatus 1 enables a user to select one guidance route suiting his or her preferences from multiple guidance routes. The controller 2 performing the route selection process can act as a route selection section or means.

The navigation apparatus 1 may be configured such that, in addition to guidance routes to places for arrival of the destination facility, a guidance route to a representative point of a destination facility may be retrieved at B5 in FIG. 4.

According to an aspect of the above-described embodiments and modifications, a navigation apparatus for a vehicle is provided. The navigation apparatus includes: a map data storage section storing therein road map data; a departure point setting section configured to set a departure point; a destination point setting section configured to set a destination point; a guidance route retrieval section configured to retrieve a guidance route between the departure point and the destination point based on the road map data; and a navigation route setting section configured to set a navigation route for use in route guidance based on the retrieved guidance route. When the destination point setting section sets the destination point to a facility having a plurality of places for arrival, the guidance route retrieval section retrieves a plurality of guidance routes that respectively leads from the departure point to the plurality of places for arrival; and when the plurality of guidance routes includes one guidance route that does not require the vehicle to make a U-turn on a road around the facility, the navigation route setting section sets the navigation route to the one guidance route.

According to the above navigation apparatus, when the retrieved guidance routes include a guidance route that does not require a vehicle to make a U-turn on a road around a facility, in other words, when the retrieved guidance routes include a guidance route that is considered to be a most optimum route from the departure point, the navigation route is set to such an optimum route. It is thus possible to set the navigation route to a guidance route that suppresses complication of driving on a road around a facility. It is possible to provide a user with an appropriate navigation route that enables the user to easily reach a destination facility. In the above, the navigation route is set based on the first condition that a guidance route does not require a vehicle to make a U-turn on a road around a facility.

According to the above navigation apparatus, there is a possibility that the retrieved guidance routes include two or more guidance routes each not requiring a vehicle to make a U-turn on a road around a facility. Taking this situation into consideration, the above navigation apparatus may be configured such that, when the guidance routes includes two or more guidance routes each not requiring a vehicle to make a U-turn on a road around a facility, the navigation route setting section sets the navigation route to a shortest one of the two or more guidance routes. According to this configuration, even when there are two or more guidance routes each not requiring a vehicle to make a U-turn on a road around a facility, it is possible to provide a user with an appropriate navigation route by selecting a shortest guidance route from the two or more guidance routes. In the above, the navigation route is set according to the second condition that a guidance route is shortest.

According to the above navigation apparatus, there is a possibility that each of the retrieved guidance routes requires a vehicle to make a U-turn on a road around a facility. Taking this situation into consideration, the above navigation apparatus may be configured such that, when each of the retrieved guidance routes requires a vehicle to make a U-turn on a road around a facility, the navigation route setting section sets the navigation route to a shortest one of the retrieved guidance routes. According to this configuration, even if the selection of any one of guidance routes brings a requirement for a vehicle to make a U-turn, it is possible to provide a user with an appropriate navigation route by selecting a shortest guidance route from the retrieved guidance routes. In the above, the navigation route is set according to the second condition that a guidance route is shortest.

According to the above navigation apparatus, a navigation route is set based on one of or a combination of the first condition and the second condition, the first condition being such that a guidance route does not require a vehicle to make a U-turn on a road around a facility, the second condition being such that a guidance route is shortest. Thus, there may be a possibility that, although a user should go to a certain one of multiple places for arrival, the navigation route is not set to a guidance route leading to the certain one of multiple places for arrival. Taking into this possibility, into consideration, the above navigation apparatus may be configured such that: each of the places for arrival is settable as the destination point by the destination point setting section; and when the destination point setting section sets the destination point to one of the places for arrival, the guidance route retrieval section retrieves the guidance route that leads from the departure point to the one of the places for arrival. According to this configuration, a user can set the destination point to a desired place for arrival. Even if a route that suits user preference and leads from the departure point to the certain place for arrival does not satisfy the first or second condition, it is possible to set the navigation route to the guidance route suiting user preference.

The above navigation apparatus may further include a route selection section for route selection, and may be configured such that: when the guidance routes includes multiple guidance routes each satisfying a predetermined selection condition for being the navigation route, the route selection section causes the navigation route to be user-selectable from the multiple guidance routes; and when one of the multiple guidance routes is selected, the navigation route setting section sets the navigation route to the selected one of the multiple guidance routes. According to this configuration, it is possible to provide an appropriate navigation route even when, for example, the retrieved guidance routes include multiple guidance route each satisfying the first and/or second conditions. By enabling a user to select one guidance route from the multiple guidance routes, it is possible to perform route guidance in way more suiting user preference.

While the invention has been described above with reference to various embodiments thereof, it is to be understood that the invention is not limited to the above described embodiments and constructions. The invention is intended to cover various modifications and equivalent arrangements. In addition, while the various combinations and configurations described above are contemplated as embodying the invention, other combinations and configurations, including more, less or only a single element, are also contemplated as being within the scope of embodiments. Further, each or any combination of procedures, processes, steps, or means explained in the above can be achieved as a software section or unit (e.g., subroutine) and/or a hardware section or, unit (e.g., circuit or integrated circuit), including or not including a function of a related device; furthermore, the hardware section or unit can be constructed inside of a microcomputer.

Furthermore, the software section or unit or any combinations of multiple software sections or units can be included in a software program, which can be contained in a computer-readable storage media or can be downloaded and installed in a computer via a communications network.

What is claimed is:

1. A navigation apparatus for a vehicle, comprising:
a map data storage section storing therein road map data;
a departure point setting section configured to set a departure point;
a destination point setting section configured to set a destination point;
a guidance route retrieval section configured to retrieve a guidance route between the departure point and the destination point based on the road map data; and
a navigation route setting section configured to set a navigation route for use in route guidance based on the retrieved guidance route,
wherein:
when the destination point setting section sets the destination point to a facility having a plurality of places for arrival, the guidance route retrieval section retrieves a plurality of guidance routes that respectively leads from the departure point to the plurality of places for arrival; and
when the plurality of guidance routes includes one guidance route that does not require the vehicle to make a U-turn on a road around the facility, the navigation, route setting section sets the navigation route to the one guidance route.

2. The navigation apparatus according to claim 1, wherein:
when the plurality of guidance routes includes two or more guidance routes each not requiring the vehicle to make the U-turn on the road around the facility, the navigation route setting section sets the navigation route to a shortest one of the two or more guidance routes.

3. The navigation apparatus according to claim 1, wherein:
when each of the plurality of guidance routes requires the vehicle to make the U-turn on the road around the facility, the, navigation route setting section sets the navigation route to a shortest one of the plurality of guidance routes.

4. The navigation apparatus according to claim 1, wherein:
each of the plurality of places for arrival is settable as the destination point by the destination point setting section; and
when the destination point setting section sets the destination point to one of the plurality of places for arrival, the guidance route retrieval section retrieves the guidance route that leads from the departure point to the one of the plurality of places for arrival.

5. The navigation apparatus according to claim 1, further comprising:
a route selection section for guidance route selection,
wherein:
when the plurality of guidance routes includes multiple guidance routes each satisfying a predetermined selection condition for being the navigation route, the route selection section causes the navigation route to be user-selectable from the multiple guidance routes; and
when one of the multiple guidance routes is selected, the navigation route setting section sets the navigation route to the selected one of the multiple guidance routes.

6. The navigation apparatus according to claim 1, wherein:
when the plurality of guidance routes includes two or more guidance routes each not requiring the vehicle to make the U-turn on the road around the facility, the navigation route setting section sets the navigation route to a shortest one of the two or more guidance routes;
when each of the plurality of guidance routes requires the vehicle to make the U-turn on the road around the facility, the navigation route setting section sets the navigation route to a shortest one of the plurality of guidance routes;
each of the plurality of places for arrival is settable as the destination point by the destination point setting section; and
when the destination point setting section sets the destination point to one of the plurality of places for arrival, the guidance route retrieval section retrieves the guidance route that leads from the departure point to the one of the plurality of places for arrival,
the navigation apparatus further comprising:
a route selection section for guidance route selection,
wherein:
when the plurality of guidance routes includes multiple guidance routes each satisfying a predetermined selection condition for being the navigation route, the route selection section causes the navigation route to be user-selectable from the multiple guidance routes; and
when one of the multiple guidance routes is selected, the navigation route setting section sets the navigation route to the selected one of the multiple guidance routes.
